(19) United States
(12) Patent Application Publication
(10) Pub. No.: US 2011/0243643 A1
(43) Pub. Date: Oct. 6, 2011

(54) Cleaning device

(75) Inventor: Kuan-Di Huang, Sanchong City (TW)

(73) Assignees: Kuan-Di Huang, Sanchong City (TW); Su-Shan Chen, Sanchong City (TW)

(21) Appl. No.: 12/801,989

(22) Filed: Jul. 7, 2010

(30) Foreign Application Priority Data
Mar. 31, 2010 (TW) 099205636

(51) Int. Cl. B43M 11/06

(52) U.S. Cl. 401/261

(57) ABSTRACT

The present invention is to provide a cleaning device having a housing, a cleaner bottle and a wiping element combined together, wherein the housing has a first receiving space for accommodating the cleaner bottle and an opening for allowing a part of a sprayer of the cleaner bottle to project out of the housing and be pressed by a user. The cleaner bottle is filled with a cleaner and the sprayer has a spray nozzle wherein, when the sprayer is pressed by the user, the cleaner is sprayed out of the spray nozzle to the wiping element, so that the cleaner can be absorbed by the wiping element and then immediately diffused outward to a peripheral surface of corresponding part of the wiping element, and be used to wipe surface of an article (such as a computer screen) and rapidly and completely clean dirt out of the article.

### FIELD OF THE INVENTION

The present invention relates to a cleaning device, more particularly to a cleaning device having a cleaner bottle and a wiping element combined together as a whole for enabling a user to cause cleaner in the cleaner bottle to be sprayed onto the wiping element, so that the cleaner can be absorbed by the wiping element and then diffused outward to a peripheral surface of corresponding part of the wiping element, and enabling the user to use the wiping element to immediately wipe the surface of the article (such as a computer screen) and rapidly and completely clean dirt out of the article.

### BACKGROUND OF THE INVENTION

Nowadays, when people clean an article, most of people firstly handle a cleaner bottle to spray a cleaner (i.e. cleaning solution) on the article, and then take a cleaning cloth to wipe and thereby clean the surface of the article. For example, when cleaning a liquid crystal display (LCD), a user generally needs to hold the LCD by one hand, and to hold a cleaner bottle by another hand for spraying a cleaner to the surface of the LCD by the cleaner bottle. After spraying, the cleaner on the surface of the LCD will flow downward due to the effect of gravity, so that the user must immediately put the cleaner bottle aside and rapidly take a cleaning cloth to wipe the surface of the LCD wetted by the cleaner and then to absorb the redundant cleaner by the cleaning cloth, for the purpose of preventing the cleaner from flowing downward into the inner space of the LCD through gaps (such as those along the peripheral frame) of the surface thereof. Once the user fails to completely remove the cleaner in time and the cleaner flows into the inner space of the LCD through the gaps thereof, various internal components (such as printed circuit board, terminals, LEDs, etc.) in the LCD may be in contact with the cleaner and corrosion or a short-circuit problem may be caused by the cleaner, resulting in the breakdown or damage of the LCD and causing the considerable lose of the user.

Furthermore, during cleaning, the user generally put the cleaner bottle in a side position where the user can reach, and thus the user may ignore the position of the cleaner bottle to accidentally kick or knock over the cleaner bottle. As a result, the leaked cleaner may cause the environmental pollution. Meanwhile, children may easily take the cleaner bottle and accidentally drink the cleaner to cause serious danger.

As described above, there are several disadvantageous existing in the foregoing traditional cleaning method and the used cleaning tool thereof (i.e. the cleaner bottle and the cleaning cloth), both of which cause the inconvenience of the user and low cleaning efficiency. Therefore, it is important to think how to prevent the cleaner from directly spraying onto the surface of an article and to overcome the problem of the traditional cleaning tool that easily causes the redundant cleaner to flow into the inner space of the article through gaps of the surface thereof, resulting in the breakdown or damage of the article.

It is therefore tried by the inventor to develop a cleaning device to solve the problems existing in the traditional cleaning tool that causes several disadvantages including the inconvenience of usage and storage, the high risk of knocking over the bottle, the problem of the redundant cleaner flowing into the inner space of the article through the gaps of the article to cause the damage of the article, and the danger of the cleaner bottle easily taken by the children to accidentally drink the cleaner, as described above.

### BRIEF SUMMARY OF THE INVENTION

A primary object of the present invention is to provide a cleaning device for cleaning a surface of an article, the cleaning device comprises a housing, a cleaner bottle and a wiping element, wherein the housing is formed with a first receiving space therein, and the housing has a plurality of connection bases correspondingly formed on an inner surface of the first receiving space, wherein each of the connection bases is formed with a second receiving space therein, and the housing is further formed with an opening communicated with the first receiving space. The cleaner bottle has a bottle body for being filled with a cleaner and a sprayer formed with a spray nozzle. When the sprayer is pressed, the cleaner in the bottle body is sprayed out of the spray nozzle. The cleaner bottle is received and positioned in the first receiving space, while a part of the sprayer is projected out of the housing through the opening for being pressed by a user. The wiping element has a base formed with a first opening and at least one connection portion, wherein the first opening is formed on the base at a positional corresponding to the spray nozzle. The connection portion and the base are integrated into one piece, while the connection portion has a profile matched with that of the second receiving space in the connection bases. Thus, the connection portion can be inserted and positioned in the second receiving space of the connection bases, so that the housing can be combined with the base and the cleaner bottle, respectively. Furthermore, the base has a surface opposite to the connection portion, wherein the surface is provided with a porous elastomer and a wiping layer in order, and the porous elastomer and the wiping layer are exposed out of the housing. The porous elastomer is made of absorbent foam or sponge material, and has a recess (the recess can be omitted) or a through hole formed at a position corresponding to the spray nozzle of the sprayer. The wiping layer is covered on a surface of the porous elastomer opposite to the base. Therefore, when the housing is combined with the cleaner bottle and the wiping element respectively, the user can press the sprayer to cause the cleaner to be sprayed into the recess (or the through hole) through the spray nozzle and the first opening in order, so that the cleaner can be absorbed by a part of the porous elastomer and the wiping layer corresponding to the first opening (or be absorbed by a part of the wiping layer corresponding to the through hole) and then diffused outward to a peripheral surface of the corresponding part of the porous elastomer and the wiping layer. Meanwhile, the user can use the wiping layer to immediately wipe the surface of the article (such as a computer screen). When the user uses the wiping layer to exert a force toward the surface of the article, the porous elastomer is compressed by the force and the cleaner absorbed in the porous elastomer can be suitably leaked to the wiping layer, so that the cleaner in the wiping layer can be used to fully wet and soften the dirt on the surface of the article. As a result, the user can use the wiping layer to wipe the fully softened dirt, and use the wiping layer and the porous elastomer to absorb the redundant cleaner remaining on the surface of the article, so that the effect of rapidly and completely cleaning dirt can be carried out.

To achieve the above object, the present invention provides a cleaning device comprising a cleaner bottle having a bottle body for being filled with a cleaner and a sprayer connected to the bottle body, wherein a liquid releasing opening formed on the bottle body or the sprayer can be opened to spray the cleaner filled in the bottle body outward when the sprayer is pressed; and a wiping element having a base formed with a first opening and at least one connection portion, wherein the connection portion is directly or indirectly combined with the base and the cleaner bottle while the first opening is formed at a position corresponding to the liquid releasing opening, the base has a surface opposite to the connection portion, the surface is provided with a porous elastomer and a wiping layer in order, and the wiping layer is covered on a surface of the porous elastomer opposite to the base.

In a first preferred embodiment of the present invention, the cleaning device further comprises a housing having a first receiving space and a second receiving space, wherein the cleaner bottle is received in the first receiving space, a part of the sprayer is projected out of the housing, and the base is positioned in the second receiving space, so that the housing is combined with the base and the cleaner bottle respectively, and the porous elastomer and the wiping layer are exposed out of the housing.

In a second preferred embodiment of the present invention, the cleaning device further comprises a housing having a first receiving space and a second receiving space, wherein the cleaner bottle is received in the first receiving space, a part of the sprayer is projected out of the housing, and the connection portion is positioned in the second receiving space, so that the housing is combined with the base and the cleaner bottle respectively, and the porous elastomer and the wiping layer are exposed out of the housing.

In the first and second embodiments, the housing further comprises a second opening, which is aligned with the first opening and the liquid releasing opening when the housing is combined with the base and the cleaner bottle respectively.

In a third preferred embodiment of the present invention, the connection portion is positioned on the cleaner bottle at a position corresponding to the liquid releasing opening.

In the above embodiments, the porous elastomer is made of absorbent foam or sponge material, or has a recess or a through hole formed at a position corresponding to the liquid releasing opening of the sprayer.

### BRIEF DESCRIPTION OF THE SEVERAL VIEWS OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a cleaning device according to a first preferred embodiment of the present invention;

FIG. 2 is an assembled cross-sectional view of the cleaning device according to the first preferred embodiment of the present invention;

FIG. 3 is a cross-sectional view of a cleaning device according to a second preferred embodiment of the present invention; and

FIG. 4 is a cross-sectional view of a cleaning device according to a third preferred embodiment of the present invention.

### DETAILED DESCRIPTION OF THE INVENTION

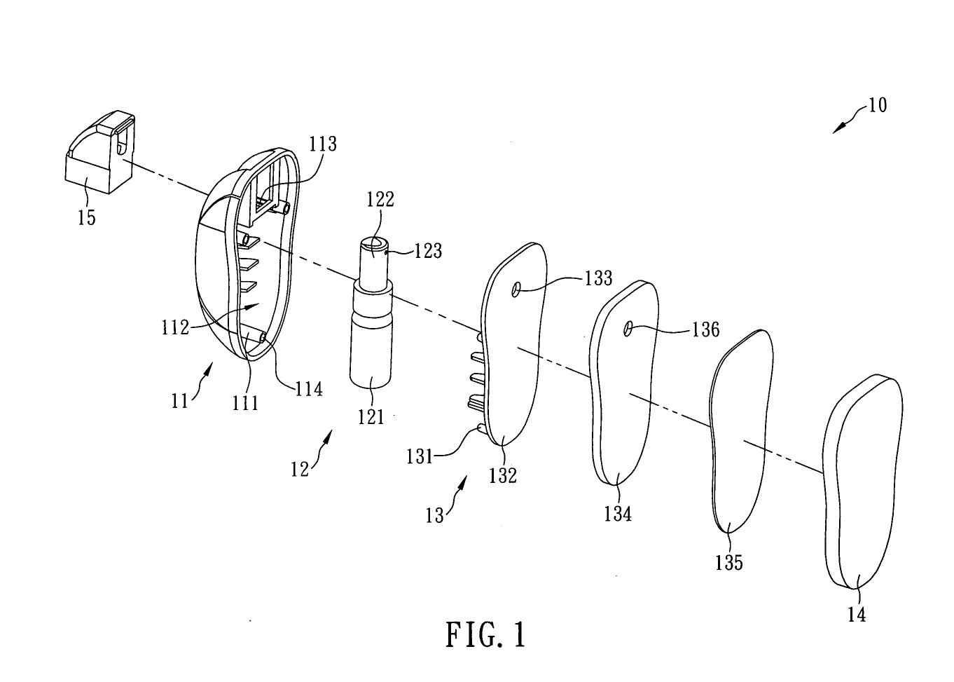

The present invention is a cleaning device used for cleaning dirt on a surface of an article. In a first preferred embodiment of the present invention, referring now to FIG. 1, a cleaning device 10 comprises a housing 11, a cleaner bottle 12 and a wiping element 13, wherein the housing 11 is formed with a first receiving space 112 therein, and the housing 11 has a plurality of connection bases 111 correspondingly formed on an inner surface of the first receiving space 112, wherein each of the connection bases 111 is formed with a second receiving space 114 therein, and the housing 11 is further formed with an opening 113 communicated with the first receiving space 112. The cleaner bottle 12 has a bottle body 121 for being filled with a cleaner therein, and further has a sprayer 122 having a spray nozzle 123 (also referred to as “a liquid releasing opening” in the claims of the present invention). When the sprayer 122 is pressed, the cleaner in the bottle body 121 is sprayed out from the spray nozzle 123. The cleaner bottle 12 is received and positioned in the first receiving space 112, while a part of the sprayer 122 is projected out of the housing 11 through the opening 113 for being pressed by a user.

Furthermore, the wiping element 13 has a base 132 formed with a first opening 133 and at least one connection portion 131, wherein the first opening 133 is formed on the base 132 at a position corresponding to the spray nozzle 123. The connection portion 131 and the base 132 are integrated into one piece, while the connection portion 131 has a profile matched with that of the second receiving space 114 in the connection bases 111. Thus, the connection portion 131 can be inserted and positioned in the second receiving space 114 of the connection bases 111, so that the housing 11 can be combined with the base 132 and the cleaner bottle 12 respectively. Moreover, the base 132 has a surface opposite to the connection portion 131, wherein the surface is provided with a porous elastomer 134 and a wiping layer 135 in order, and the porous elastomer 134 and the wiping layer 135 are exposed out of the housing 11. The porous elastomer 134 is made of absorbent foam or sponge material, and has a through hole 136 formed at a position corresponding to the spray nozzle 123 of the sprayer 122. The wiping layer 135 is covered on a surface of the porous elastomer 134 opposite to the base 132.

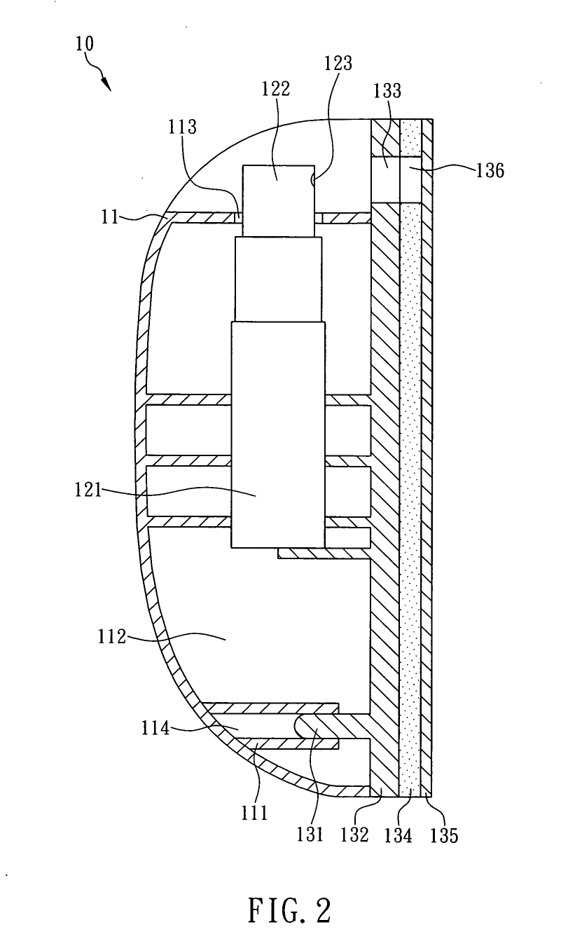

Referring now to FIGS. 1 and 2, in the first preferred embodiment of the present invention, when the housing 11 is combined with the cleaner bottle 12 and the wiping element 13 respectively, the user can press the sprayer 122 to cause the cleaner to be sprayed into the through hole 136 through the spray nozzle 123 and the first opening 133 in order, so that the cleaner can be absorbed by a part of the porous elastomer 134 corresponding to the first opening 133 and a part of the wiping layer 135 corresponding to the through hole 136, and then the cleaner is diffused outward to a peripheral surface of the corresponding part of the porous elastomer 134 and the wiping layer 135. Meanwhile, the user can use the wiping layer 135 to immediately wipe the surface of the article (such as a LCD). When the user uses the wiping layer 135 to exert a force toward the surface of the article, the porous elastomer 134 is compressed by the force and the cleaner absorbed in the porous elastomer 134 can be suitably leaked to the wiping layer 135, so that the cleaner in the wiping layer 135 can be used to fully wet and soften the dirt on the surface of the article. As a result, the user can use the wiping layer 135 to wipe the fully softened dirt, and use the wiping layer 135 and the porous elastomer 134 to absorb the redundant cleaner remaining on the surface of the article. As a result, the present invention can prevent the problems of the traditional cleaning tool which directly sprays the cleaner onto the surface of the article and thus cause the redundant cleaner to flow into the inner space of the article through gaps of the surface thereof, wherein various internal components in the article will be in contact with the cleaner to cause a corrosion or a short-circuit problem by the cleaner, resulting in the breakdown or damage of the article. Thus, the present invention can carry out the effect of rapidly and completely cleaning dirt. In addition, the cleaning device 10 further comprises a cover 14 which is formed with a receiving recess (not shown) on one side, so that the porous elastomer 134 and the wiping layer 135 can be received in the receiving recess. Therefore, when the user uses the cleaning device 10 to finish a cleaning operation, the user can then use the cover 14 to completely cover the porous elastomer 134 and the wiping layer 135, in order to prevent dirt in the air from being adhered to the porous elastomer 134 and the wiping layer 135 to affect the cleaning effect of the cleaning device 10. Besides, the cleaning device 10 further comprises lid 15 which is covered on the part of the sprayer 122 projected out of the housing 11, in order to prevent the user from accidentally pressing the sprayer 122 and avoid the cleaner from being leaked out of the housing 11 from the spray nozzle 123.

Furthermore, referring back to FIG. 1, in other embodiments of the present invention, the wiping layer 135 can be a sponge layer, or made of flannel, paper, wool felt, cotton, non-woven fabric or the equivalent. Thus, when the wiping layer 135 wipes a fine surface of an article (such as a mirror or a screen), the surface of the article can not be scared by the wiping layer 135.

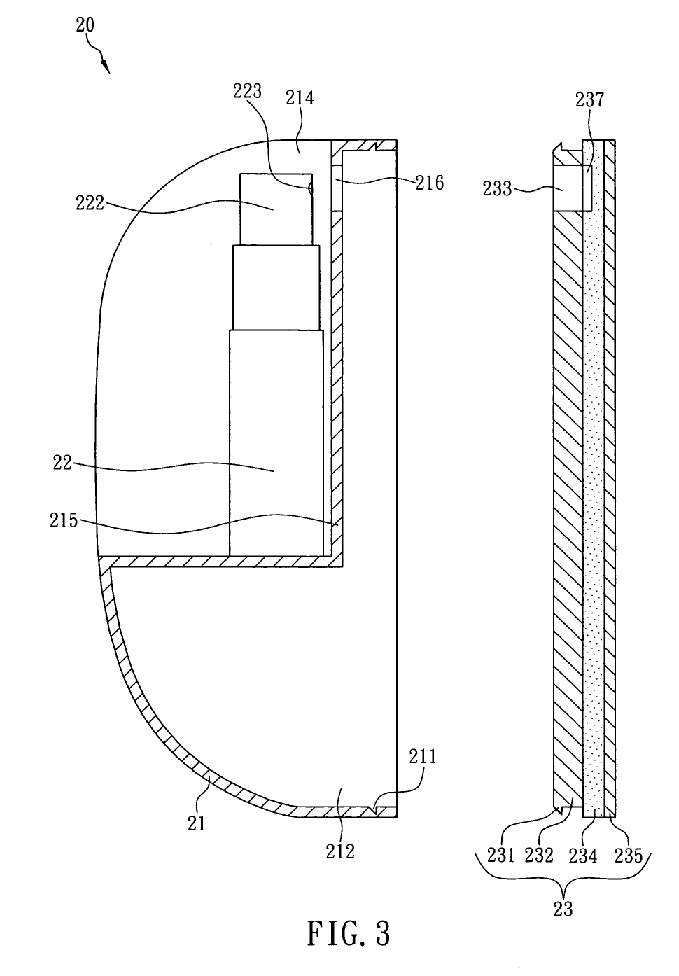

Referring now to FIG. 3, in a second preferred embodiment of the present invention, a cleaning device 20 comprises a housing 21, a cleaner bottle 22 and a wiping element 23, wherein the housing 21 is formed with a first receiving space 214 and a second receiving space 212 therein, and the housing 21 has a plurality of connection bases 211 correspondingly formed on an inner surface of the second receiving space 212 close to an end edge of the second receiving space 212. A separation plate 215 is formed between the first receiving space 214 and the second receiving space 212, wherein the separation plate 215 is formed with a second opening 216 on the separation plate 215 close to an end edge of one side thereof. Thus, the first receiving space 214 and the second receiving space 212 can be communicated with each other through the second opening 216. Furthermore, the cleaner bottle 22 is received in the first receiving space 214, and a part of a sprayer 222 is projected out of the housing 21 from the first receiving space 214 for being pressed by a user. Meanwhile, a spray nozzle 223 of the sprayer 222 is aligned with the second opening 216. The wiping element 23 comprises a base 232 which has a first opening 233 and at least one connection portion 231. In the embodiment, the connection portion 231 is an engagement element. The first opening 233 is formed on the base 232 at a position corresponding to the spray nozzle 223 and the second opening 216. The connection portion 231 and the base 232 are integrated into one piece, while the connection portion 231 has a profile matched with a recessed profile of the connection bases 211. Thus, the connection portion 231 can be engaged with the connection bases 211 and positioned in the second receiving space 212, so that the housing 21 can be combined with the base 232 and the cleaner bottle 22 respectively. Furthermore, the base 232 has a surface opposite to the connection portion 211, wherein the surface is provided with a porous elastomer 234 and a wiping layer 235 in turn, and the porous elastomer 234 and the wiping layer 235 are exposed out of the housing 21. The porous elastomer 234 has a recess 237 formed at a position corresponding to the first opening 233 of the base 232. The wiping layer 235 is covered on a surface of the porous elastomer 234 opposite to the base 232. Therefore, when the housing 21 is combined with the cleaner bottle 22 and the wiping element 23 respectively, the user can press the sprayer 222 to cause the cleaner to be sprayed into the recess 237 through the spray nozzle 223, the second opening 216 and the first opening 233 in order, so that the cleaner can be absorbed by a part of the porous elastomer 234 and the wiping layer 235 corresponding to the recess 237 and then diffused outward to a peripheral surface of the corresponding part of the porous elastomer 234 and the wiping layer 235. Meanwhile, the user can use the wiping layer 235 to immediately wipe the surface of an article.

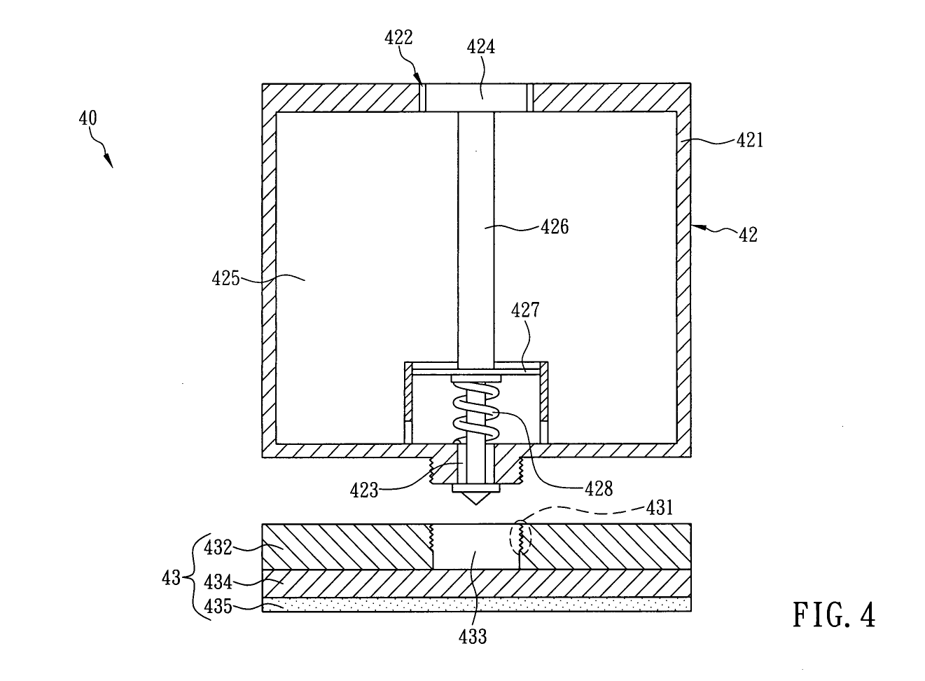

Referring now to FIG. 4, in a third preferred embodiment of the present invention, a cleaning device 40 comprises a cleaner bottle 42 and a wiping element 43, wherein the cleaner bottle 42 has a bottle body 421 and a sprayer 424, while the bottle body 421 and the sprayer 424 are connected with each other. The bottle body 421 has a first end formed with a push-button opening 422, and a second end formed with a liquid dripping opening 423 (also referred to as “a liquid releasing opening” in the claims of the present invention). Furthermore, the bottle body 421 is formed with a receiving space 425 therein, wherein the receiving space 425 is used to fill with a cleaner and to receive the sprayer 424. The sprayer 424 has a central post 426 and an end portion fixedly connected to a first end of the central post 426. Meanwhile, a second end of the central post 426 is passed through the liquid dripping opening 423 on the second end of the bottle body 421, and an inner edge of the second end of the central post 426 is abutted against an outer edge of the second end of the bottle body 421, so that the liquid dripping opening 423 is shielded by the second end of the central post 426. In addition, the central post 426 further has a stop plate 427, and a spring 428 is sleeved on the second end of the central post 426, wherein the spring 428 has a first end biased against a side surface of the stop plate 427 away from the sprayer 424 and a second end biased against a position of an inner bottom of the bottle body 421 close to the liquid dripping opening 423. Moreover, the wiping element 43 comprises a base 432 which has a first opening 433 and at least one connection portion 431. The first opening 433 is formed on the base 432 at a position corresponding to the liquid dripping opening 423. The connection portion 431 and the base 432 are integrated into one piece, while the connection portion 431 can be positioned at a position corresponding to the liquid dripping opening 423. In the preferred embodiment, the connection portion 431 is a plurality of female threads, while the second end of the bottle body 421 has a plurality of male threads which can be screw-connected to the female threads. Thus, the connection portion 431 can be positioned on the position corresponding to the liquid dripping opening 423 on the second end of the bottle body 421, so that the base 432 and the cleaner bottle 42 can be combined with each other. Furthermore, the base 432 has a surface opposite to the connection portion 431, wherein the surface is provided with a porous elastomer 434 and a wiping layer 435 in turn, and the wiping layer 435 is covered on a surface of the porous elastomer 434 opposite to the base 432. Therefore, when the sprayer 424 is pressed, the central post 426 is actuated to shift downward. At that time, the stop plate 427 on the central post 426 can overcome the bias provided by the spring 428 and compress the spring 428 downward. Thus, the inner edge of the second end of the central post 426 is separated from the outer edge of the second end of the bottle body 421, so that the liquid dripping opening 423 will be opened. As a result, the cleaner in the receiving space 425 can flow outward through the liquid dripping opening 423, and flow toward the surface of the porous elastomer 434 through the first opening 433 corresponding to the liquid dripping opening 423. Hence, the cleaner can be absorbed by the porous elastomer 434 and then diffused outward to a peripheral surface of a corresponding part of the porous elastomer 434 and the wiping layer 435. In addition, when the sprayer 424 is not pressed, the stop plate 427 on the central post 426 is pushed by the bias of the spring 428, so as to actuate the central post 426 to shift upward to an original position. Thus, the inner edge of the second end of the central post 426 is abutted against the outer edge of the second end of the bottle body 421 again, so that the liquid dripping opening 423 will be shielded again and the cleaner will not be allowed to flow outward.

It should be noted that the term “liquid releasing opening” are used in claims of the present invention to cover the spray nozzle or the liquid dripping opening described in the foregoing embodiments. Furthermore, the terms and descriptions used in the foregoing embodiments, such as the descriptions of the first and second openings, the positions of the recess and the through hole and the relative positions of the first and second receiving spaces, are only preferred embodiments of the present invention, while the present invention are not limited to the terms and descriptions. It is understood that many changes and modifications to the described embodiment can be carried out without departing from the scope and the spirit of the invention that is intended to be limited only by the appended claims.

What is claimed is:

1. A cleaning device, comprising:
a cleaner bottle having a bottle body for being filled with a cleaner and a sprayer connected to the bottle body, wherein a liquid releasing opening formed on the bottle body or the sprayer is opened to spray the cleaner filled in the bottle body outward when the sprayer is pressed; and
a wiping element having a base formed with a first opening and at least one connection portion, wherein the connection portion is directly or indirectly combined the base and the cleaner bottle together, the first opening is formed at a position corresponding to the liquid releasing opening, the base has a surface opposite to the connection portion and provided with a porous elastomer and a wiping layer in order, and the wiping layer is covered on a surface of the porous elastomer opposite to the base.

2. The cleaning device according to claim 1, wherein the connection portion is positioned on the cleaner bottle at a position corresponding to the liquid releasing opening.

3. The cleaning device according to claim 1, further comprising:
a housing having a first receiving space and a second receiving space, wherein the cleaner bottle is received in the first receiving space, a part of the sprayer is projected out of the housing, and the base is positioned in the second receiving space, so that the housing is combined with the base and the cleaner bottle respectively, and the porous elastomer and the wiping layer are exposed out of the housing.

4. The cleaning device according to claim 1, further comprising:
a housing having a first receiving space and a second receiving space, wherein the cleaner bottle is received in the first receiving space, a part of the sprayer is projected out of the housing, and the connection portion is positioned in the second receiving space, so that the housing is combined with the base and the cleaner bottle respectively, and the porous elastomer and the wiping layer are exposed out of the housing.

5. The cleaning device according to claim 3, wherein the housing has a second opening which is aligned with the first opening and the liquid releasing opening when the housing is combined with the base and the cleaner bottle respectively.

6. The cleaning device according to claim 4, wherein the housing has a second opening which is aligned with the first opening and the liquid releasing opening when the housing is combined with the base and the cleaner bottle respectively.

7. The cleaning device according to claim 5, wherein the porous elastomer is made of absorbent foam or sponge material.

8. The cleaning device according to claim 6, wherein the porous elastomer is made of absorbent foam or sponge material.

9. The cleaning device according to claim 5, wherein the porous elastomer has a recess or a through hole formed at a position corresponding to the liquid releasing opening of the sprayer.

10. The cleaning device according to claim 6, wherein the porous elastomer has a recess or a through hole formed at a position corresponding to the liquid releasing opening of the sprayer.
